(19) United States
(12) Patent Application Publication
(10) Pub. No.: US 2008/0204594 A1
(43) Pub. Date: Aug. 28, 2008

(54) VIDEO SIGNAL CONVERTER WITH SIGNAL FILTER

(75) Inventors: Leroy SUTTON, Wheeling, IL (US); John Tran, Chicago, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wells Gardner Electronics Corporation, McCook, IL (US)

(21) Appl. No.: 12/038,211

(22) Filed: Feb. 27, 2008

Related U.S. Application Data
(60) Provisional application No. 60/891,898, filed on Feb. 27, 2007.

(51) Int. Cl. H04N 7/01

(52) U.S. Cl. 348/453; 348/E07.003

(57) ABSTRACT

A video signal converter converts a color graphics array (CGA) video signal to a video graphics array (VGA) video signal without a horizontal sync spike. The converter includes an input interface, a conversion circuit and an output interface. The input interface is configured to receive a color graphic array (CGA) video signal. The conversion circuit is configured to convert the CGA video signal to a video graphic array (VGA) video signal. The output interface is configured to output the VGA video signal with a reduced horizontal sync spike. This is necessary for the use of auto-alignment of the LCD display

### CROSS-REFERENCES TO RELATED APPLICATIONS

This application claims priority under 35 U.S.C. § 119(e) to U.S. Provisional Application Ser. No. 60/891,898 filed on Feb. 27, 2007, which is hereby incorporated by reference for all purposes as if fully set forth herein.

### BACKGROUND OF THE INVENTION

1. Field of the Disclosure

The disclosure is directed to video signal processing, and more particularly, to converting a color graphics array (CGA) video signal to a video graphics array (VGA) video signal without a horizontal sync spike.

2. Related Art

A color graphics adapter was introduced in 1981 by IBM as the first color graphics card and the first color computer display standard for the IBM personal computer (PC). When IBM introduced the PC Advanced Technology (AT) and the Enhanced Graphics Adapter (EGA) in 1984, the price of color graphic cards dropped, making color graphic cards an attractive low-cost solution for entry-level non-AT PCs with CGA graphics. Although the popularity of color graphic adapter's started to wane after a Video Graphics Array (VGA) standard became IBM's high-level solution and EGA the entry-level solution in 1987, the color graphic adapters are still being used in certain industries, such as, for example, the console-based video gaming industry for casinos, and the like. The CGA standard uses various connectors, including a standard DE-10 connector, or the like, depending on applications.

The VGA standard was initially introduced in 1987 by IBM with a 640×480 standard resolution for use with graphics color systems operating in conformance with a VGA standard. The VGA standard was the first graphical standard that the majority of computer manufacturers conformed to, making it the lowest common denominator to support PC graphics hardware, before a device-specific driver is loaded into a computer. Generally, a VGA color system is backwards compatible with the EGA and CGA standards.

Recent advances in flat panel display technology have made flat panel displays such as LCDs (liquid crystal display) or plasma displays, more affordable and, hence, more desirable for display devices such as gaming consoles (e.g., slot machines, video poker machines, and the like). Generally speaking, flat panel displays are lighter, less bulky, consume less power and capable of displaying more vivid and aesthetically-pleasing graphics than cathode ray tube (CRT) displays. In order to receive a video signal from an external video signal source (e.g., a graphics card), the flat panel display devices are typically equipped with a VGA connector, which is also known as an RGB connector, D-sub 15, mini sub D15 and mini D15. Moreover, larger numbers of flat panel displays on the market are equipped with a digital visual interface (DVI) connector. However, flat panel display devices on the market are often not equipped with a 10 pin CGA connector.

Accordingly, there is a need for a simple and cost-effective solution to allow a flat panel display device to receive and display a video signal in the CGA standard.

### BRIEF SUMMARY OF THE INVENTION

The disclosure meets the foregoing need and provides a simple, low-profile and cost-effective solution for a flat panel display device to receive a CGA video signal without a horizontal sync spike coupled into the video from the signal cable and other advantages apparent from the disclosure provided herein.

Accordingly, in one aspect of the invention, a video signal converter includes an input interface configured to receive a color graphic array (CGA) video signal, a conversion circuit configured to convert the CGA video signal to a video graphic array (VGA) video signal, and an output interface configured to output the VGA video signal with the reduced horizontal sync spike coupled into the video signal.

The conversion circuit may be configured to reduce a horizontal sync pulse in the CGA video signal. Reducing the horizontal sync pulse may include differentiating an edge of the horizontal sync pulse and/or adding a differential signal. The differential signal may be of an opposite polarity than the horizontal sync pulse. The CGA video signal may include a red input signal, a blue input signal, a green input signal, a vertical sync input signal, a horizontal sync input signal and a ground signal. The input interface may include a plurality of input terminals, where a red input terminal may be configured to receive the red input signal, a green input terminal may be configured to receive the green input signal, a blue input terminal may be configured to receive the blue input signal, a vertical sync input terminal may be configured to receive the vertical sync input signal, and a horizontal sync input terminal may be configured to receive the horizontal sync input signal. The output interface may include a plurality of output terminals, where a red output terminal may be coupled to the red input terminal, a green output terminal may be coupled to the green input terminal, a blue output terminal may be coupled to the blue input terminal, a vertical sync output terminal may be coupled to the vertical sync input terminal, and a horizontal sync output terminal may be coupled to the horizontal sync input terminal. The conversion circuit may include a first node coupled between the red input terminal and the red output terminal, a second node coupled between the green input terminal and the green output terminal, a third node coupled between the blue input terminal and the blue output terminal, a fourth node coupled between the horizontal sync input terminal and the horizontal sync output terminal, a fifth node coupled between the fourth node and at least one of the first, second and third nodes, a first capacitor coupled between the first node and the fifth node, a second capacitor coupled between the second node and the fifth node, a third capacitor coupled between the third node and the fifth node, and a first resistor couple between the horizontal sync input terminal and the fourth node. The conversion circuit may also include a second resistor coupled between the fourth node and the fifth node or coupled between the fifth node and a ground. The conversion circuit may also include at least one of a third resistor coupled between the first node and the red output terminal, a fourth resistor coupled between the second node and the green output terminal and a fifth resistor coupled between the third node and the blue output terminal. A circuit board may implement the conversion circuit, where the input and output interfaces are mounted on the circuit board. The output interface may be a 15 pin D-Sub connector, and the input interface may be a CGA 10 pin connector. A liquid crystal display (LCD) device may include the video signal converter.

According to another aspect of the invention, a video signal converter includes means for receiving a computer graphic array (CGA) video signal, means for converting the CGA video signal to a video graphic array (VGA) video signal, and means for outputting the VGA video signal with a reduced horizontal sync spike to a display device.

The means for converting may be configured to reduce the horizontal sync spike of the CGA video signal. Reducing the horizontal sync pulse may include differentiating an edge of the horizontal sync pulse and/or adding a differential signal. The differential signal may be of an opposite polarity than the horizontal sync pulse. The receiving means may also include means for engaging a CGA 9 pin connector. The outputting means may include means for engaging a 15 pin D-Sub connector. The video signal converter may also include means for holding the receiving means, converting means, reducing means and outputting means.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate exemplary embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a flat panel display device;

FIG. 2 shows a CGA to VGA adaptor constructed according to the principles of the disclosure, connected to a VGA port of a flat panel display device;

FIG. 3 is a circuit schematic of the CGA to VGA adaptor of FIG. 2, constructed according to the principles of the disclosure;

FIG. 4(a) shows a graphical representation of a CGA video signal having a horizontal sync spike;

FIG. 4(b) shows a graphical representation of a CGA video signal processed by the CGA to VGA adaptor of FIGS. 2 and 3;

FIG. 5(a) shows a VGA output connector of the CGA to VGA adaptor of FIG. 2, constructed according to the principles of the disclosure;

FIG. 5(b) shows a CGA input connector of the CGA to VGA adaptor of FIG. 2, constructed according to the principles of the disclosure;

FIG. 5(c) shows a side perspective view of the CGA to VGA adaptor of FIG. 2, constructed according to the principles of the disclosure, in which the VGA output connector of FIG. 5(a) and the CGA input connector of FIG. 5(b) are mounted on a circuit board; and

FIG. 5(d) shows a supporting leg of the circuit board of FIG. 5(c), constructed according to the principles of the disclosure for support when installed into the LCD display.

### DETAILED DESCRIPTION OF THE INVENTION

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

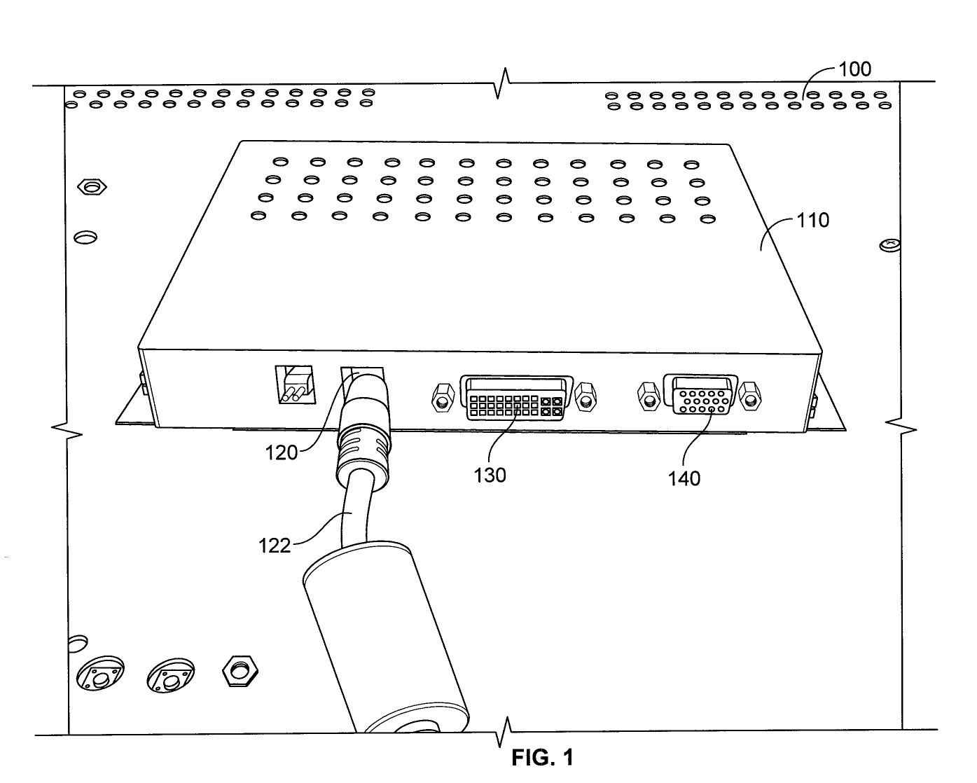

As mentioned above, the CGA standard is becoming superseded by newer video standards, such as VGA. However, the CGA standard is still being used in certain industries such as, for example, the video gaming industry for casinos. Thus, a need exists to implement flat panel display devices in CGA-based gaming consoles (e.g., video poker and slot machines and the like). According to the principles of the disclosure, a CGA to VGA adaptor may be used to convert a received CGA signal to a VGA signal and provide the converted VGA signal to a flat panel display device, such as, for example, a flat panel display (FPD) device 100 (shown in FIG. 1) via an existing video port.

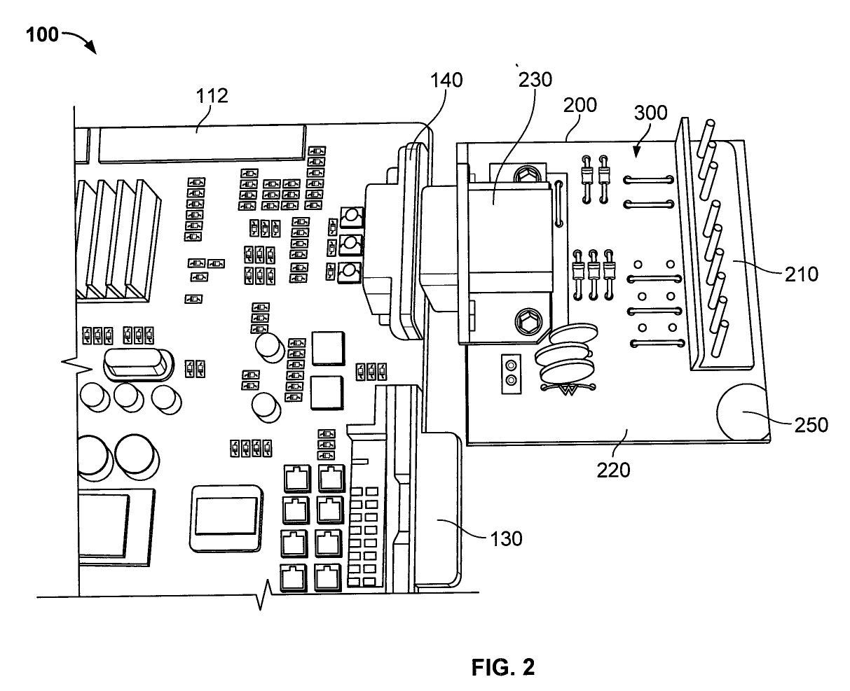

FIG. 1 shows a rear side of a flat panel display (FPD) device 100. As shown, the FPD 100 is equipped with a power cord plug receiver 120 configured to receive a power cord plug 122, a digital visual interface (DVI) port 130 and a video graphics array (VGA) port 140. The VGA port 140 is connectable to a driving circuit 112 (shown in FIG. 2) mounted on a rear surface of an FPD (not shown) and covered by a rear cover 110.

According to the exemplary embodiment of the disclosure, the FPD device 100 is an LCD device. However, as the skilled artisan will readily recognize, without departing from the scope and/or spirit of the disclosure, the FPD device 100 may be another type of display, such as, for example, a liquid crystal display (LCD), a plasma display, an organic light-emitting diode display (OLED), a light emitting diode display (LED), an electroluminescent display (ELD), a surface-conduction electron-emitter display (SED), a field emission display (FED), a nano-emissive display (NED), or any other display device capable of manifesting an image signal.

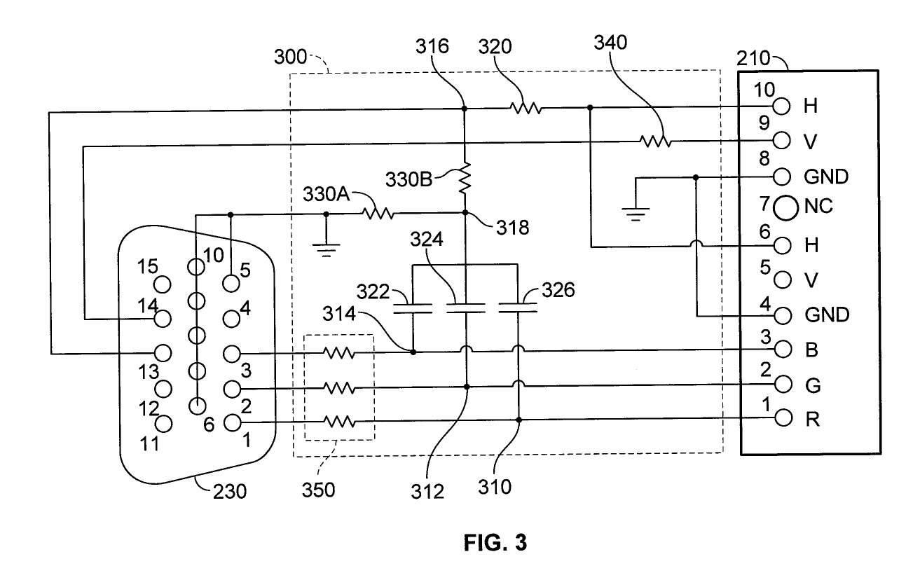

FIG. 2 shows a CGA to VGA adaptor 200 connected to the VGA port 140 of the FPD device 100 shown in FIG. 1. As shown therein, the adaptor 200 may include a CGA input connector 210 configured to receive a CGA signal, a circuit board 220 and a VGA output connector 230 configured to output a VGA signal. The CGA input connector 210 may be configured to receive a CGA input signal from an external video signal source, such as, for example, but not-limited to, a personal computer, a workstation computer, a gaming computer, and the like. The exemplary non-limiting CGA input connector 210 is shown in FIGS. 2 and 3 as a 9-pin single line male connector configured to engage a video cable which stems from the external video signal source and has a corresponding 9-pin female connector. However, as the skilled artisan will readily recognize and appreciate, without departing from the scope and/or spirit of the disclosure, the CGA connector may be configured to have any number of pins and/or shapes, including, for example, a female connector having a plurality of receivers for male pins configured in any number of lines, circles, squares, triangles, or the like, a combination of male-female connectors having both pins and receivers for pins configured in any number of lines, circles, squares, triangles, or the like, or any other connector structure capable of connecting the adaptor 200 to a CGA signal source.

The CGA input connector 210 may be attached to the circuit board 220, as shown, e.g., in FIG. 2. The circuit board 220 may include a format conversion (FC) circuit 300 for converting the CGA input signal to a VGA output signal, which is described below in detail. In addition to converting the CGA input signal to the VGA output signal, the FC circuit 300 may filter the CGA input signal to eliminate horizontal sync spikes, as described below in detail. The VGA output connector 230 may be attached to the circuit board 220, as is known in the art, to receive the VGA output signal from the FC circuit 300 and forward the signal to the FPD device 100.

As shown in FIG. 2, for example, the VGA output connector 230 may be directly connected to the VGA port 140 of the FPD device 100 to transfer the VGA output signal from the FC circuit 300 to the circuit board 112, in the FPD device 100. The VGA output connector 230 may be a 15-pin 3-line male RGB connector, which may be configured to engage a corresponding 15-pin 3-line female RBG connector. However, the VGA output connector 230 may, instead, have any number of pins and/or receivers arranged in any combination of lines, circles, squares, triangles, or any other pin/receiver configuration in a male and/or female connector configuration, as the skilled artisan will readily recognize and appreciate, with out departing from the scope and/or spirit of the disclosure.

Additional components may be added to the CGA to VGA adaptor 200, such as, for example, a cover (not shown) that may be added to protect the circuit board 220 from external ambient conditions. The cover (not shown) may be hermetically sealed to a casing (not shown), enclosing the CGA to VGA adaptor 200.

Alternatively, the CGA to VGA adaptor 200 may be formed into a single, hermetically sealed structure (not shown) configured to be tamper resistant, with or without covers.

When the VGA output connector 230 is directly mounted on the circuit board 200, there may be a gap between the FPD device 100 and the circuit board 200, as shown in FIG. 2. Thus, when a CGA input cable (not shown) is coupled to the CGA input connector 210, the coupling force used to connect the CGA input cable to the input connector 210 may cause the circuit board 200 to bend, which may damage the circuit 300 formed thereon. To prevent this, it may be necessary to add a support leg 250 which extends from the circuit board 200 to the rear surface of the FPD device 100.

FIG. 3 shows an exemplary, non-limiting circuit schematic of the CGA to VGA adaptor 200 of FIG. 2, constructed according to the principles of the disclosure. As mentioned above, the CGA input connector 210 may have 10 pins to engage the CGA input cable. An exemplary pin configuration of the CGA input terminal 210 is described in Table 1.

TABLE 1
CGA Input Connector Pin Configuration

| Pin Number | Signal |
|---|---|
| 1 | Red |
| 2 | Green |
| 3 | Blue |
| 4 | Ground |
| 5 | Vertical Sync |
| 6 | Horizontal Sync |
| 7 | No Connection |
| 8 | Ground |
| 9 | Vertical Sync |
| 10 | Horizontal Sync |

The VGA output connector 230 may have 15 pins to engage the VGA port 140 of the FPD device 100. An exemplary pin configuration of the VGA output terminal 230 is described in Table 2.

TABLE 2
VGA Output Connector Pin Configuration

| Pin Number | Signal |
|---|---|
| 1 | Red |
| 2 | Green |
| 3 | Blue |
| 4 | Not Connected |
| 5 | Ground |
| 6 | Red Return |
| 7 | Green Return |
| 8 | Blue Return |
| 9 | +5 V (DDC) |
| 10 | Ground |
| 11 | Not Connected |
| 12 | SDA (I²C Data) |
| 13 | Horizontal Sync |
| 14 | Vertical Sync |
| 15 | SCL (I²C Clock) |

To convert a CGA video input signal received on a CGA input cable having the CGA pin configuration to a VGA output signal to be output on a VGA pin configuration, the circuit 300 is configured to interconnect the corresponding pins of the CGA input connector 210 and the VGA output connector 230. More specifically, the FC circuit 300 may interconnect the first pin of the CGA input connector 210 and the first pin of the VGA output connector 230 to transfer the red signal. Similarly, the second pins of the CGA input connector 210 and the VGA output connector 230 may be interconnected to transfer the green signal. Also, the third pins of the CGA input connector 210 and the VGA output connector 230 may be interconnected to transfer the blue signal. Resistor 350 may be coupled between the first, second and third pins of the CGA input connector 210 and the VGA output connector 230, respectively, to reduce the signal strength of the red, green and blue input signals received by the CGA input connector 210, if necessary.

The FC circuit 300 may interconnect the fourth and eighth ground pins of the CGA input connector 210 to a common ground. The ninth pin of the CGA input connector 210 and the fourteen pin of the VGA output connector 230 may be interconnected to transfer the vertical sync signal. A resistor 340 may be coupled between the ninth pin of the CGA input connector 210 and the fourteenth pin of the VGA output connector 230, depending on a signal level of a vertical sync signal applied thereto. The tenth pin of the CGA input connector 210 and the thirteenth pin of the VGA output connector 230 may be interconnected to transfer a horizontal sync signal. Moreover, the sixth pin of the CGA input connector 210 is designated for the horizontal sync signal, and hence may be connected to the tenth pin of the CGA input connector 210, as long as both the sixth pin and the tenth pin carry the same horizontal sync signal.

Since the VGA output terminal 230 may have more pins than the CGA input terminal 210, certain pins of the VGA output terminal 230 may not be interconnected to the pins of the CGA input terminal 210. For example, the fourth, sixth to twelfth and fifteenth pins of the VGA output terminals 230 may not be connected to the pins of the CGA input terminal 210. Among them, the fifth (ground), sixth (red return), seventh (green return), eighth (blue return), ninth (+5 V) and tenth (ground) pins may be connected to the ground. The fourth and eleventh pins (not connected) and twelfth (SDA) and fifteenth (SCL) pins may be left unconnected to any pins or ground. By interconnecting the corresponding pins of the CGA input connector 210 and the VGA output connector 230, the CGA input signal is converted to the VGA output signal.

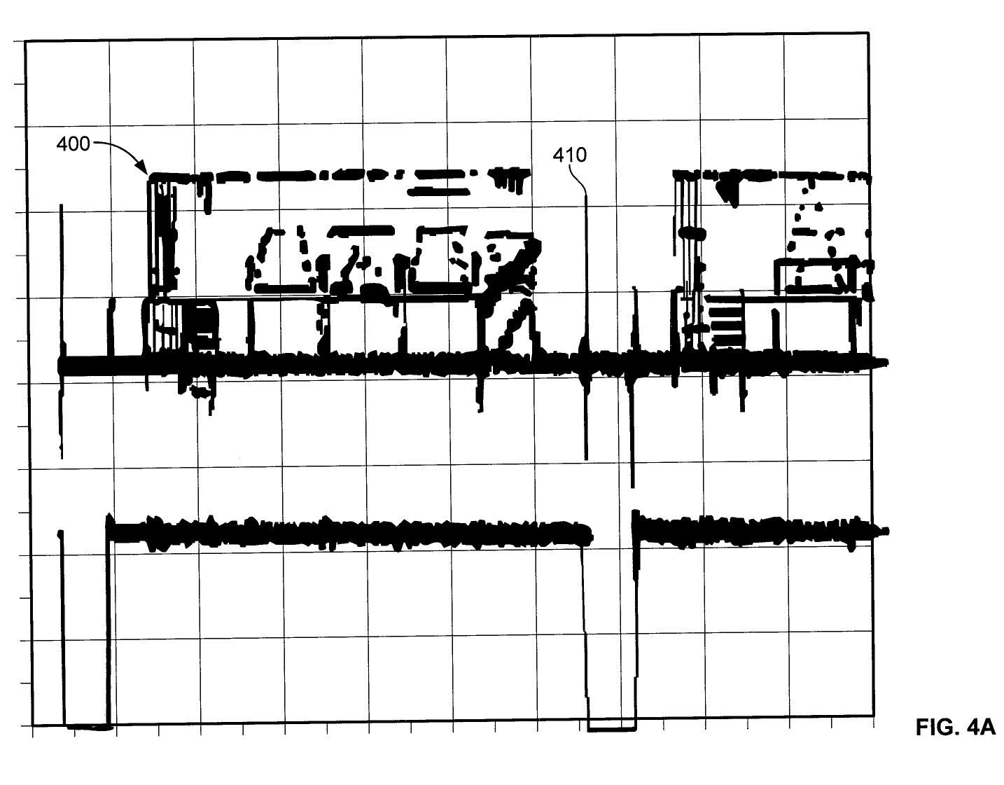

The FC circuit 300 may also be configured to filter the received CGA input signal in order to reduce a horizontal sync spike. For example, FIG. 4(a) shows an exemplary graphical representation of the CGA input signal 400 provided to the CGA connector 210 from the external CGA signal source. As shown therein, the CGA input signal 400 has a spike 410 that is consistent with a horizontal sync pulse. The spike 410 is originally inserted to indicate a horizontal sync point for use by a cathode tube ray (CRT) display. When applied to a flat panel display device, however, the spike 410 may trigger the auto-sizing function of the display device and may set the screen size incorrectly. This problem may be addressed by implementing the signal filtering feature in the FC circuit 300.

To implement the signal filtering feature, the FC circuit 300 in FIG. 3 may further include a plurality of resistors 320, 330A (or 330B), 340 and a plurality of capacitors 322, 324, 326 to reduce or eliminate the horizontal sync spike 410. The circuit 300 may also include a plurality ofnodes 310, 312, 314, 316, 318. The node 310 maybe coupled between the first pins (red) of the CGA input connector 210 and the VGA output connector 230. Capacitor 326 may be located between node 310 and node 318. The node 312 may be coupled between the second pins (green) of the CGA input connector 210 and the VGA output connector 230. Capacitor 324 may be located between node 312 and node 318. The node 314 may be coupled between the third pins (blue) of the CGA input connector 210 and the VGA output connector 230. Capacitor 322 may be located between node 314 and node 318. The node 316 may be coupled between the tenth pin (horizontal sync) of the CGA input connector 210 and the thirteenth pin of the VGA output connector 230. The node 318 may be coupled between the node 316 and the capacitors 322, 324, 326.

The capacitors 322, 324, 326 may each have a capacitance value, for example, of about 100 pf. However, as the skilled artisan will readily recognize and appreciate, the capacitance value may be any value determined to be appropriate for a particular application, without departing from the scope and/or spirit of the disclosure. Moreover, the capacitance value of each of the capacitors 322, 324 and 326 may not necessarily be the same, but may differ for each of the capacitors.

The resistor 320 may be coupled between the tenth pin (horizontal sync) of the CGA input connector 210 and the node 316. The resistor 320 may have a resistance value of for example, about 220 ohm. However, as the skilled artisan will readily recognize and appreciate, the resistance value may be any value determined to be appropriate for a particular application, without departing from the scope and/or spirit of the disclosure.

In one embodiment, only one of the resistors 330A and 330B may be formed in the FC circuit 300. The resistor 330A may be coupled between the node 318 and the ground, and the resistor 330B may be coupled between the nodes 316 and 318. This arrangement may remove the spike 410 by differentiating an edge of the horizontal sync pulse and adding a differential signal of an opposite polarity. The resultant signal is shown in FIG. 4(b), in which the spike 410 shown in FIG. 4(a) is substantially eliminated as indicated by the reference number 420. Thus, the VGA output video signal provided to the FPD device 100 will have a proper screen size, without the mal-effects caused by horizontal sync spikes in the FPD device 100.

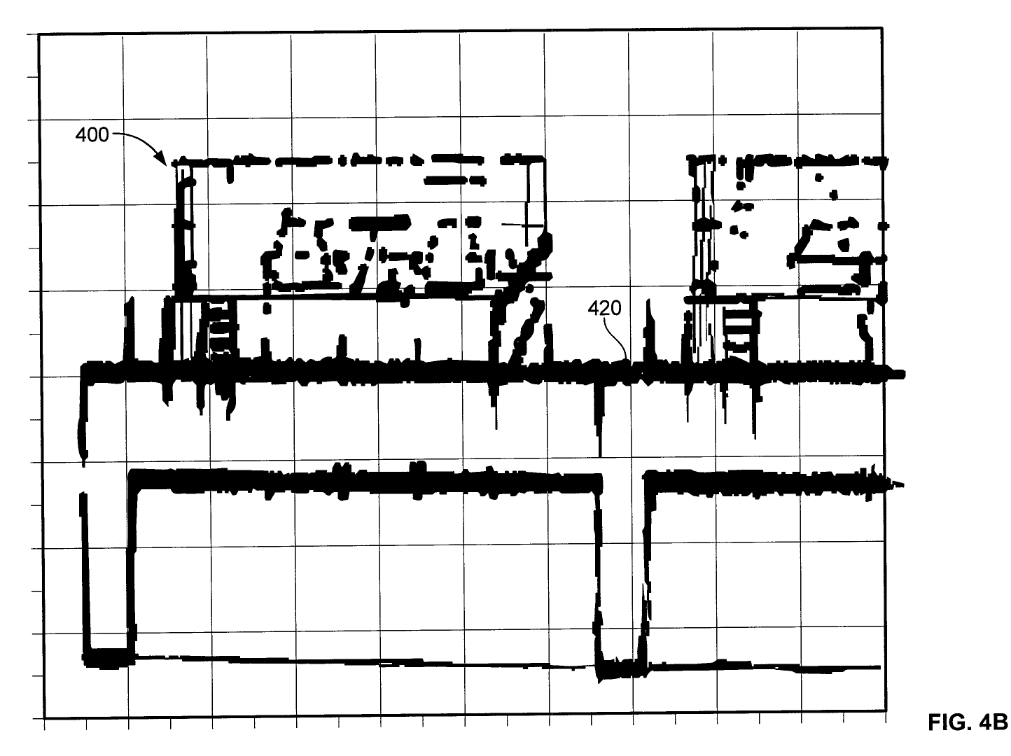

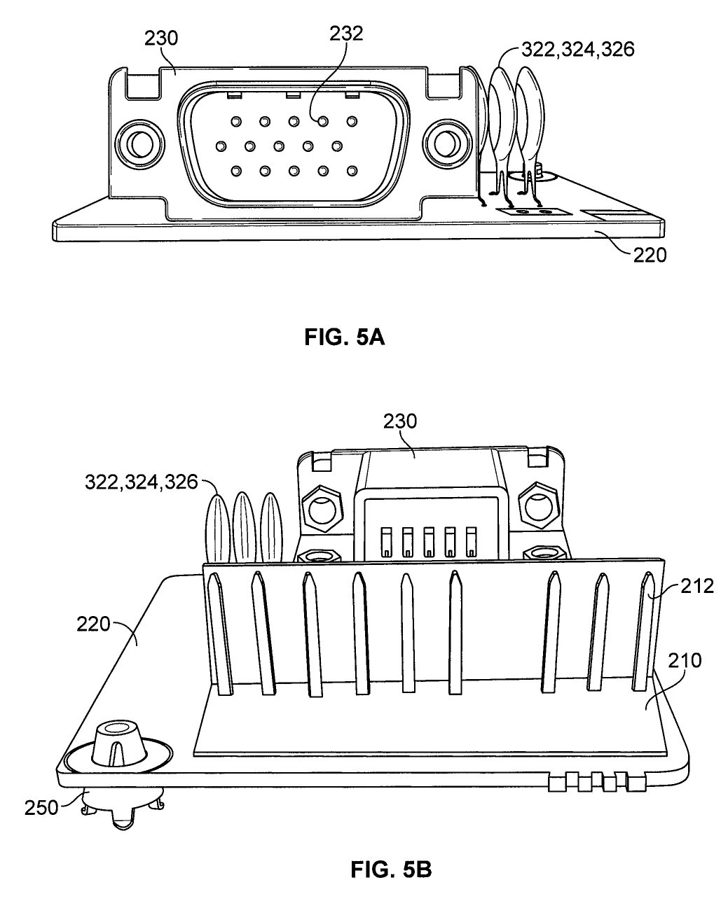

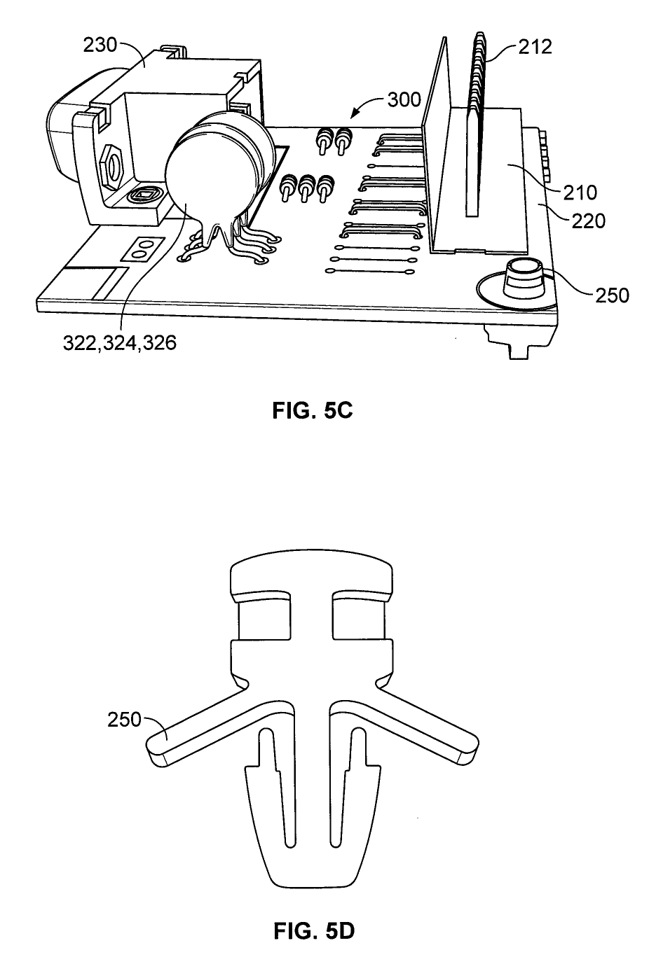

FIGS. 5(a), 5(b), 5(c) and 5(d) show various views of the adaptor 200. For example, FIG. 5(a) shows the VGA output connector side of the CGA to VGA adaptor 200. As shown therein, the VGA output connector 230 may be a male RGB connector having 15 pins 232 configured in three lines of pins. Furthermore, the capacitors 322, 324, 326 may be directly mounted on the circuit board 220.

FIG. 5(b) shows the CGA input connector side of the adaptor 200, in which the CGA input connector 210 includes 10 pins 212 configured in a single line of pins.

FIG. 5(c) shows a side view of the CGA to VGA adaptor 200, which particularly shows the FC circuit 300 arranged on the circuit board 220. Also, FIG. 5(c) shows the supporting leg 250 attached to a bottom corner of the circuit board 220.

FIG. 5(d) shows a detailed view of one exemplary, although non-limiting, embodiment of the supporting leg 250. As shown therein, the supporting leg 250 may be configured to easily attach to the circuit board 220, but not easily detach therefrom while supporting the circuit board 210. The skilled artisan will recognize that any support member capable of supporting the CGA to VGA adaptor 200 may be used in place of, or in addition to the supporting leg 250, including, an anchoring pin member, a screw, and the like, without departing from the scope and/or spirit of the disclosure.

Accordingly, the invention provides a simple and cost-effective solution for a flat panel display device to receive a CGA input signal while reducing horizontal sync spikes, which results in an improved video quality. Particularly, the CGA to VGA adaptor constructed according to the principles of the disclosure provides an economic, durable, low-profile and easy-to-use solution to the problems that industries, such as, for example, the video gaming industry, are now facing without elaborate modification of existing flat panel display devices.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the disclosure.

What is claimed is:

1. A video signal converter, comprising:
an input interface configured to receive a color graphic array (CGA) video signal;
a conversion circuit configured to convert the CGA video signal to a video graphic array (VGA) video signal; and
an output interface configured to output the VGA video signal with a reduced horizontal sync spike.

2. The video signal converter of claim 1, wherein said conversion circuit is configured to reduce a horizontal sync pulse in the CGA video signal.

3. The video signal converter of claim 2, wherein reducing the horizontal sync pulse includes differentiating an edge of the horizontal sync pulse.

4. The video signal converter of claim 2, wherein reducing the horizontal sync pulse includes adding a differential signal.

5. The video signal converter of claim 4, wherein the differential signal is an opposite polarity than the horizontal sync pulse.

6. The video signal converter of claim 1, wherein the CGA video signal comprises a red input signal, a blue input signal, a green input signal, a vertical sync input signal, a horizontal sync input signal and a ground signal.

7. The video signal converter of claim 2, wherein said input interface comprises a plurality of input terminals, said plurality of input terminals comprising:
a red input terminal configured to receive the red input signal;
a green input terminal configured to receive the green input signal;
a blue input terminal configured to receive the blue input signal;
a vertical sync input terminal configured to receive the vertical sync input signal; and
a horizontal sync input terminal configured to receive the horizontal sync input signal.

8. The video signal converter of claim 7, wherein said output interface comprises a plurality of output terminals, said plurality of output terminals comprising:
a red output terminal coupled to said red input terminal;
a green output terminal coupled to said green input terminal;
a blue output terminal coupled to said blue input terminal;
a vertical sync output terminal coupled to said vertical sync input terminal; and
a horizontal sync output terminal coupled to said horizontal sync input terminal.

9. The video signal converter of claim 8, wherein said conversion circuit comprises:
a first node coupled between said red input terminal and said red output terminal;
a second node coupled between said green input terminal and said green output terminal;
a third node coupled between said blue input terminal and said blue output terminal;
a fourth node coupled between said horizontal sync input terminal and said horizontal sync output terminal;
a fifth node coupled between said fourth node and at least one of said first, second and third nodes;
a first capacitor coupled between said first node and said fifth node;
a second capacitor coupled between said second node and said fifth node;
a third capacitor coupled between said third node and said fifth node; and
a first resistor couple between said horizontal sync input terminal and said fourth node.

10. The video signal converter of claim 9, wherein said conversion circuit further comprises a second resistor coupled between said fourth node and said fifth node or coupled between said fifth node and a ground.

11. The video signal converter of claim 9, wherein said conversion circuit further comprises at least one of a third resistor coupled between said first node and said red output terminal, a fourth resistor coupled between said second node and said green output terminal and a fifth resistor coupled between said third node and said blue output terminal.

12. The video signal converter of claim 1, further comprising a circuit board implementing the conversion circuit, wherein said input and output interfaces are mounted on the circuit board.

13. The video signal converter of claim 12, wherein said output interface comprises a 15 pin D-Sub connector.

14. The video signal converter of claim 12, wherein said input interface comprises a CGA 10 pin connector.

15. A liquid crystal display (LCD) device comprising the video signal converter of claim 1.

16. A video signal converter, comprising:
means for receiving a computer graphic array (CGA) video signal;
means for converting the CGA video signal to a video graphic array (VGA) video signal; and
means for outputting the VGA video signal with a reduced horizontal sync spike to a display device.

17. The video signal converter of claim 16, wherein said means for converting is configured to reduce the horizontal sync spike of the CGA video signal.

18. The video signal converter of claim 17, wherein reducing the horizontal sync pulse includes differentiating an edge of the horizontal sync pulse.

19. The video signal converter of claim 17, wherein reducing the horizontal sync pulse includes adding a differential signal.

20. The video signal converter of claim 19, wherein the differential signal is an opposite polarity than the horizontal sync pulse.

21. The video signal converter of claim 16, wherein said receiving means comprises means for engaging a CGA 9 pin connector.

22. The video signal converter of claim 16, wherein said outputting means comprises means for engaging a 15 pin D-Sub connector.

23. The video signal converter of claim 16, further comprising means for holding the receiving means, converting means, reducing means and outputting means.
